(19) United States
(12) Patent Application Publication
(10) Pub. No.: US 2006/0289412 A1
(43) Pub. Date: Dec. 28, 2006

(54) Laser beam irradiation apparatus and pattern drawing method

(75) Inventor: Shiro Hamada, Yokosuka-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 11/514,165

(22) Filed: Sep. 1, 2006

Related U.S. Application Data
(63) Continuation of application No. PCT/JP04/02523, filed on Mar. 2, 2004.

(51) Int. Cl. B23K 26/06; B23K 26/067

(52) U.S. Cl. 219/121.75; 219/121.77

(57) ABSTRACT

A laser source emits a laser beam. A diffractive optical element is disposed at a position which the laser beam emitted from the laser source is incident on. The diffractive optical element splits the incident laser beam into laser beams. The laser beams are incident on a first zoom lens system. The first zoom lens system focuses the incident laser beams onto a first virtual plane.

### BACKGROUND OF THE INVENTION

1. Field of the Invention

The present invention relates to laser beam irradiation apparatus, and in particular, relates to a laser beam irradiation apparatus for irradiating an object with a plurality of laser beams with high efficiency.

2. Description of the Related Art

A technique for applying a laser beam onto a film to be transferred set in close contact with the surface of an underlying substrate to join (transfer) a laser-beam-applied part of the film to the underlying substrate is known. After the film is partially transferred, the untransferred part of the film is removed, so that a protrusion made of the transferred film is formed on the underlying substrate.

FIG. 10A shows an example of a pattern including protrusions made of a transferred film. A plurality of straight patterns 100Y parallel to the Y-axis are arranged at a pitch Px in the X-axis direction, thus forming a striped pattern.

It takes a long processing time to draw the pattern of FIG. 10A while scanning one laser beam on a substrate surface. One laser beam is split into laser beams and the laser beams are simultaneously applied onto the substrate surface, thus reducing the processing time.

Japanese Patent No. 3371304 and Japanese Unexamined Patent Application Publication No. 2000-275581 disclose a technique for splitting one laser beam into laser beams using a diffractive optical element (DOE). Since one laser beam is split into laser beams, the laser beams can simultaneously be applied onto a plurality of points on the surface of a substrate. Moving the substrate can draw the pattern including the straight patterns 100Y of FIG. 10A in one scanning.

In a case where one laser beam is split using the DOE, the arrangement of beam spots formed on a substrate is fixed. In order to change the pitch Px of the straight patterns 100Y in FIG. 10A, the DOE has to be changed to another DOE for the arrangement of beam spots with a desired pitch.

It is an object of the present invention to provide a laser beam irradiation apparatus capable of drawing straight patterns arranged at a desired pitch without changing a DOE.

FIG. 10B shows another example of a pattern including protrusions made of a transferred film. In this pattern, a plurality of straight patterns 100Y parallel to the Y-axis are arranged in the X-axis direction at a pitch Px and a plurality of straight patterns 100X parallel to the X-axis are arranged in the Y-axis direction at a pitch Py. The straight patterns 100Y intersect the straight patterns 100X, thus forming a grid pattern 100. The pattern shown in FIG. 10B defines pixels in, e.g., a flat-screen display.

When the straight patterns 100Y parallel to the Y-axis are drawn and then the other straight patterns 100X parallel to the X-axis are drawn, a laser beam is applied to each intersection in the pattern 100 twice such that the laser beam is again applied to the transferred part. Unfortunately, the second laser beam application damages each transferred part.

In drawing the straight patterns 100X, the laser beams are applied to only each portion between the straight patterns 100Y, thus preventing overlapping irradiation. According to such a method, it is, however, difficult to align the start and end points of each segment of each straight pattern 100X in drawing. More generally, in drawing a branch extending from a straight pattern, the same difficulty in aligning occurs at the branching point.

Another object of the present invention is to provide a pattern drawing method capable of a pattern including linear parts and branches extending from the linear parts such that the pattern is transferred in a desired shape.

In drawing the striped pattern shown in FIG. 10A using a pulsed laser beam, when a beam spot is overlapped with a previously transferred part, the previously transferred part is damaged as described above. It is, therefore, difficult to draw a striped pattern using the pulsed laser beam.

Further another object of the present invention is to provide a pattern drawing method capable of transferring a pattern including linear patterns using a pulsed laser beam with good reproducibility.

### 3. SUMMARY OF THE INVENTION

According to an aspect of the present invention, there is provided a laser beam irradiation apparatus comprising:

a laser source emitting a laser beam;

a diffractive optical element arranged such that the laser beam emitted from the laser source is incident on the diffractive optical element, the diffractive optical element splitting the incident laser beam into a plurality of laser beams; and

a first zoom lens system on which the split laser beams are incident, the system focusing the respective incident laser beams onto a first virtual plane.

According to another aspect of the present invention, there is provided a method for drawing a pattern, comprising the steps of:

adjusting the axes of first and second laser beams such that the beam spots of the first and second laser beams are aligned in contact with each other in a first direction on the surface of an object to be processed; and

moving the object such that the incident positions of the first and second laser beams move from a start point to an end point in a second direction intersecting the first direction while continuously applying the first laser beam from the start point to the end point and intermittently applying the second laser beam, thus drawing a pattern including a line and branches extending from the line.

According to further another aspect of the present invention, there is provided a method for drawing a pattern, comprising the steps of:

shaping the cross section of a pulsed laser beam so that the cross section includes a plurality of separated points, constituting an irradiation pattern, on the surface of an irradiated object; and

moving the incident position of the pulsed laser beam in a first direction while applying the laser beam onto the object, wherein

a travel distance between the incident position in a shot and that in the next shot is shorter than the dimension in the first direction of the irradiation pattern of the pulsed laser beam, and

the irradiation pattern and the travel distance are selected so that any of the points constituting the irradiation pattern formed in a shot does not overlap points of irradiation patterns formed in the previous and following shots.

### 4. BRIEF DESCRIPTION OF THE DRAWINGS

FIG. 1 is a schematic diagram of a laser beam irradiation apparatus according to a first embodiment.

FIG. 2 is a schematic diagram of a laser source used in the laser beam irradiation apparatus according to the first embodiment.

FIG. 3 is a plan view of a first mask used in the laser beam irradiation apparatus according to the first embodiment.

FIG. 4 is a plan view of a second mask used in the laser beam irradiation apparatus according to the first embodiment.

FIG. 5 is a plan view of a first mask according to a modification of the first embodiment.

FIG. 6 is a plan view of a second mask according to the modification of the first embodiment.

FIG. 7 is a plan view of an irradiation pattern by a pulsed laser beam for line drawing used in a drawing method according to a second embodiment.

FIG. 8 is a plan view of an irradiation pattern by a pulsed laser beam for branch drawing used in the method according to the second embodiment.

FIG. 9 is a plan view of an irradiation pattern assembly actually formed by pulsed laser beams in the method according to the second embodiment.

FIGS. 10A and 10B are plan views of examples of patterns drawn using laser beams.

FIG. 11 is a schematic diagram of diffractive optical elements included in a laser beam irradiation apparatus according to a third embodiment.

FIGS. 12A to 12C are plan views of examples of patterns drawn by the laser beam irradiation apparatus according to the third embodiment.

### 5. DESCRIPTION OF THE PREFERRED EMBODIMENTS

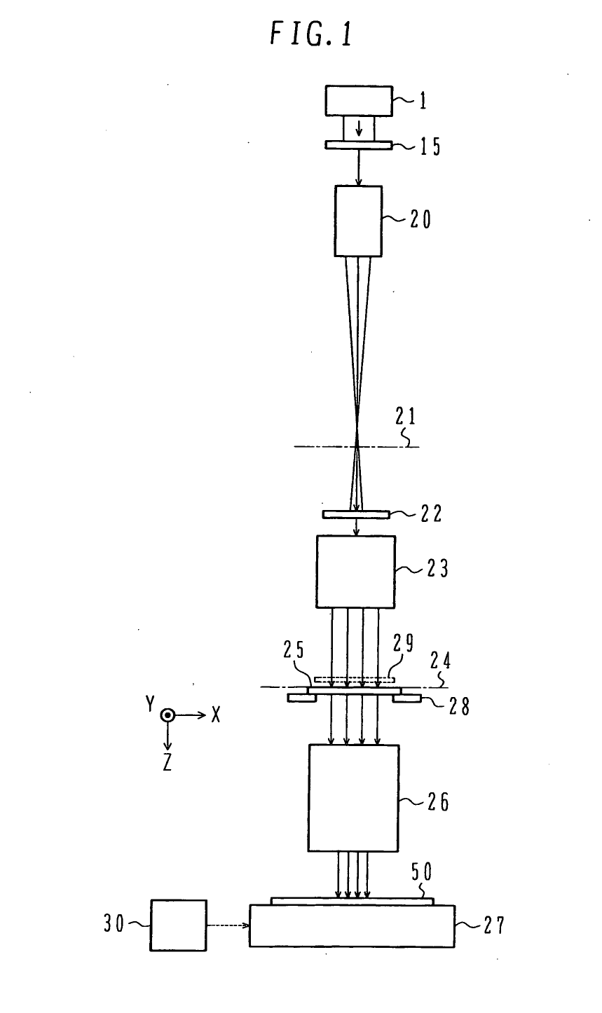

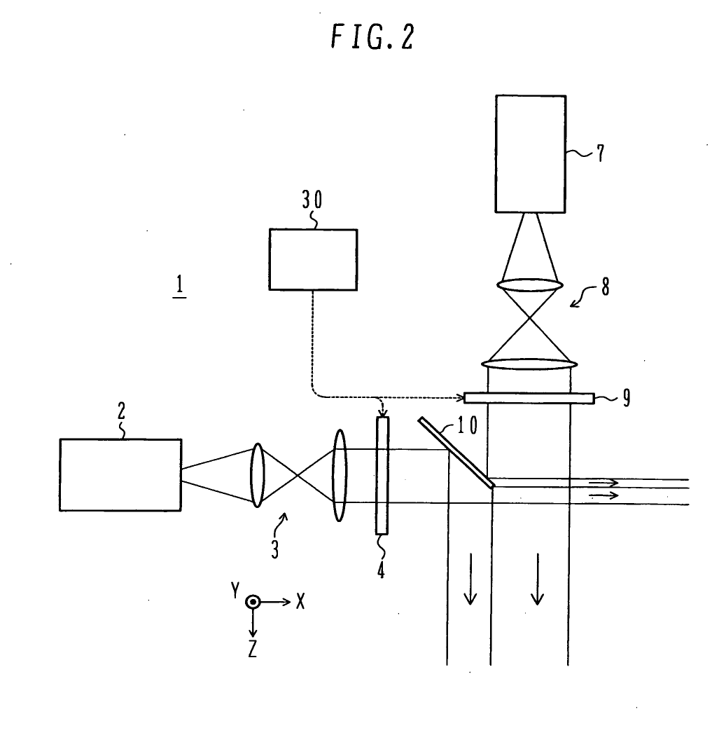

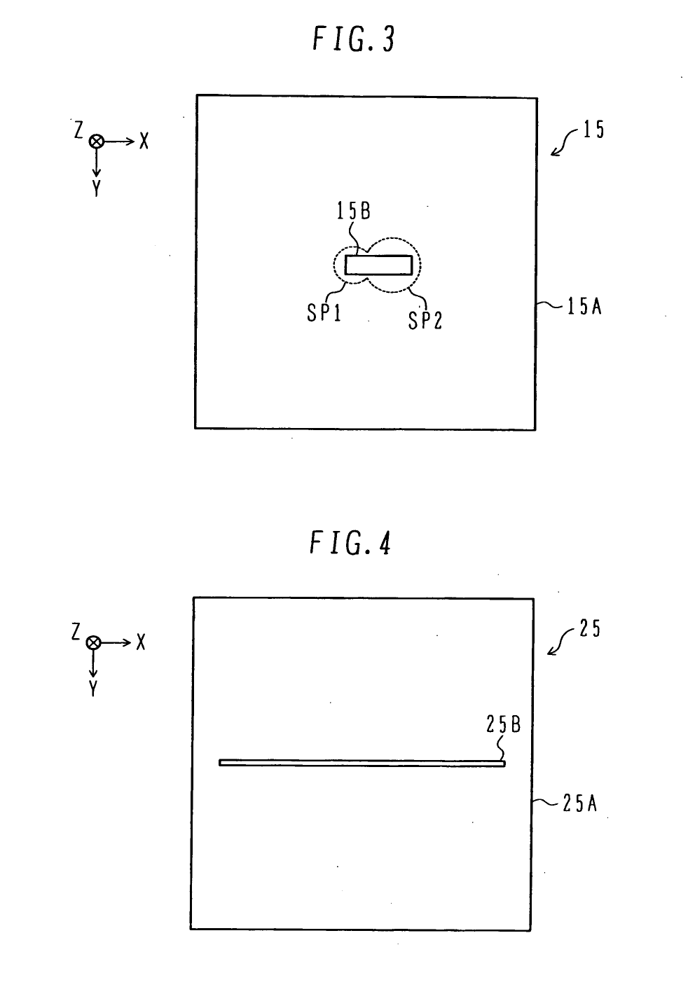

FIG. 1 shows a schematic diagram of a laser beam irradiation apparatus according to a first embodiment. A laser source 1 emits a laser beam. A first mask 15 shapes the cross section of the laser beam emitted from the laser source 1. The resultant laser beam enters a first-stage zoom lens system 20. The first mask 15 includes, e.g., a laser-beam blocking plate having a through-hole, which shapes the cross section of an incident laser beam. The first-stage zoom lens system 20 provides, on a virtual plane 21, an image of the cross section of the laser beam shaped by the first mask 15, i.e., the through-hole of the first mask 15. The imaging magnification of the lens system 20 is, e.g., 1/20 to 1/34. The detailed structure of the first mask 15 and the laser source 1 will be described below with reference to FIGS. 2 and 3.

The laser beam passing across the virtual plane 21 enters a diffractive optical element (DOE) 22. The DOE 22 splits the incident laser beam into a plurality of, e.g., 100 laser beams. The split laser beams enter a second-stage zoom lens system 23. The DOE 22 and the second-stage zoom lens system 23 provides, on a virtual plane 24, images of the aerial image on the virtual plane 21 by each of the split laser beams split by the DOE 22.

The arrangement of the aerial images formed on the virtual plane 24 depends on the DOE 22. According to the present embodiment, a plurality of (e.g., 100) aerial images are aligned along a straight line. In this instance, an XYZ orthogonal coordinate system is defined as follows: The direction of alignment of the aerial images is set to the X-axis direction. The direction of propagation of laser beams is set to the Z-axis.

A mask holder 28 holds a second mask 25 on the virtual plane 24. The second mask 25 is exchangeable as necessary. The second mask 25 includes a laser-beam blocking plate having through-holes corresponding to the aerial images formed on the virtual plane 24. The detailed structure of the second mask 25 will be described below with reference to FIG. 4.

A shutter mechanism 29 is arranged on or near the virtual plane 24. The shutter mechanism 29 blocks the split laser beams passing through points corresponding to one or some of the aerial images on the virtual plane 24.

An XY stage 27 carries an object 50 to be irradiated with laser beams. A transfer optical system 26 focuses a point on the virtual plane 24, onto the surface of the object 50 carried by the XY stage 27. The imaging magnification of the transfer optical system 26 is, e.g., ⅕. The shutter mechanism 29 blocks laser beams corresponding to one or some of the aerial images, so that the desired number of aerial images can be formed on the surface of the object 50.

A controller 30 controls the laser source 1 and the XY stage 27.

FIG. 2 is a schematic diagram of the laser source 1. The laser source 1 includes a first laser oscillator 2 and a second laser oscillator 7, each of which emits a laser beam. Semiconductor laser diodes, fiber lasers, disk lasers, or laser diode pumping solid-state lasers, such as Nd:YAG lasers are available as those laser oscillators 2 and 7. A harmonic generator may be used together in accordance with the purpose of laser machining.

A beam expander 3 increases the diameter of the laser beam emitted from the first laser oscillator 2 to form a collimated beam, which enters a shutter mechanism 4. Another beam expander 8 increases the diameter of the laser beam emitted from the second laser oscillator 7 to form a collimated beam, which enters a shutter mechanism 9. The controller 30 controls the shutter mechanisms 4 and 9 to switch between a laser-beam transmitting mode and a laser-beam blocking mode.

The shutter mechanisms 4 and 9 each include a polarizing plate for linearly polarizing a laser beam, an electro-optic modulator (EOM) exhibiting the Pockels effect, and a polarizer for transmitting the p-polarized component of an incident laser beam and reflecting the s-polarized component thereof. The transmitted p-polarized component goes straight and the reflected s-polarized component is absorbed by a beam damper. The EOM controls the direction of polarization of the laser beam, thus switching between the blocking mode in which the laser beam is reflected by the polarizer and the transmitting mode in which the laser beam is transmitted through the polarizer. An acousto-optic modulator (AOM) may be used instead of the polarizing plate, the EOM, and the polarizer.

The laser beam passing through the shutter mechanism 4 and the other laser beam passing through the other shutter mechanism 9 cross each other at 90°. A combining mirror (optical-path combiner) 10 is disposed at the intersection of the two beams. Both of the surfaces of the combining mirror 10 serve as planes of reflection. When the laser beam passing through the shutter mechanism 4 enters the front reflection plane of the combining mirror 10 at an incident angle of 45°, most part of the laser beam is reflected by the combining mirror 10. The other part of the laser beam goes straight by the combining mirror 10 and is then absorbed by the beam damper. Most part of the laser beam transmitted through the shutter mechanism 9 passes straight by the combining mirror 10. The other part thereof is incident on the back reflection plane of the combining mirror 10 at an incident angle of 45° and is reflected by the back reflection plane. The reflected part is absorbed by the beam damper.

The direction of propagation of the laser beam transmitted through the shutter mechanism 4 and reflected by the combining mirror 10 and that of the laser beam passing through the shutter mechanism 9 and going straight by the combining mirror 10 are parallel to the Z-axis. The cross sections of both the beams are aligned in the X-axis direction such that they are in contact with each other. In other words, the two laser beams are combined. The beam expanders 3 and 8 and the combining mirror 10 are disposed so that the cross section of the laser beam passing through the shutter mechanism 9 is larger than that of the laser beam passing through the other shutter mechanism 4. An attenuator controls the power densities of the respective laser beams so that the laser beams are substantially equal to each other in power density even when the laser beams have different cross-section sizes after combination. The two laser beams parallel to the Z-axis enter the first mask 15 shown in FIG. 1.

FIG. 3 is a plan view of the first mask 15. A rectangular through-hole 15B is formed in a plate 15A opaque to the laser beam. A beam spot SP1 of the laser beam emitted from the first laser oscillator 2 shown in FIG. 2 and a beam spot SP2 of the laser beam emitted from the second laser oscillator 7 are formed at a position where the first mask 15 is arranged. The beam spots SP1 and SP2 each have a circular shape partially cut along a straight line. The two beam spots SP1 and SP2 are aligned in the X-axis direction such that the linear edges of the beam spots are in contact with each other.

The through-hole 15B is positioned within the beam spots SP1 and SP2. The first mask 15 shapes the cross section of the combined laser beam into a rectangle.

FIG. 4 is a plan view of the second mask 25. A rectangular narrow through-hole 25B extending in the X-axis direction is formed in a plate 25A opaque to the laser beam. The through-hole 25B is arranged at a position where the aerial images are formed on the virtual plane 24 by the laser beams split by the DOE 22 in FIG. 1. The aerial images, corresponding to the aerial image defined by the through-hole 15B of the first mask 15, are aligned in the X-axis direction on the second mask 25. The adjacent aerial images are in contact with each other, thus forming a narrow image (assembly of aerial images) extending in the X-axis direction. The through-hole 25B is slightly smaller than the assembly of aerial images (aerial-image assembly) such that the through-hole 25B is positioned within the aerial-image assembly.

The second mask 25 shapes the cross sections of the split laser beams and also fixes a position of the aerial-image assembly on the virtual plane 24, as viewed from the transfer optical system 26, with respect to the Y-axis. The position of the aerial-image assembly on the virtual plane 24 may be deviated from a target position due to limitations in designing the DOE 22. In this case, the aerial-image assembly can be located at the target position with respect to the Y-axis using the second mask 25.

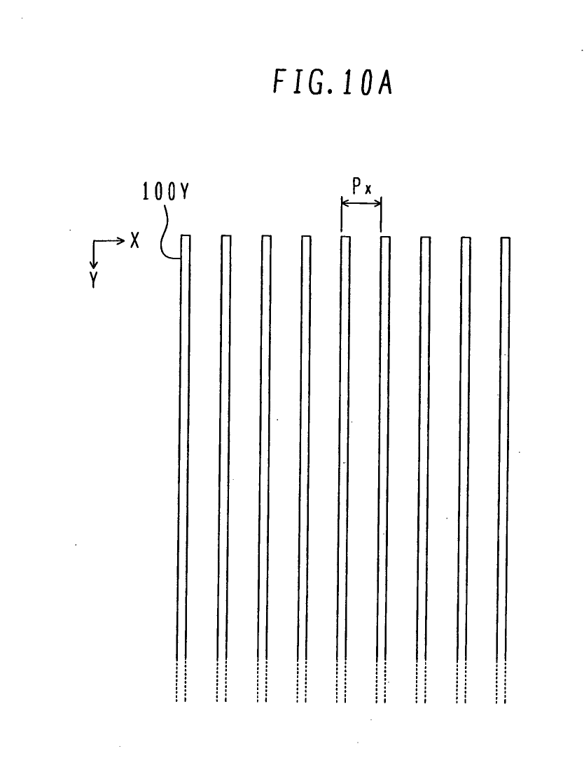

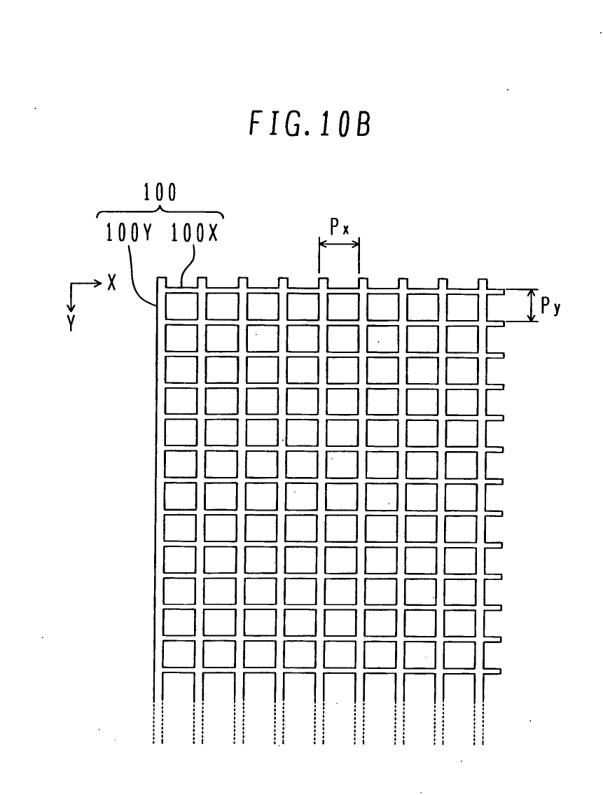

A method for drawing patterns shown in FIGS. 10A and 10B using the laser beam irradiation apparatus shown in FIGS. 1 to 3 will now be described below. In the method, an object including a substrate and a film set in close contact with the substrate is irradiated with laser beams, so that the film partially irradiated with the laser beams is joined to the substrate. CW laser oscillators for continuous-wave radiation are used as the first and second laser oscillators 2 and 7 shown in FIG. 2.

The object 50 to be irradiated is mounted on the XY stage 27 shown in FIG. 1. The shutter mechanism 4 shown in FIG. 2 is switched to the transmitting mode and the object 50 is moved in the Y-axis direction. Thus, a plurality of segments of lines 100Y parallel to the Y-axis are simultaneously drawn. Hereinafter, a segment of each line 100Y will also be referred to as a line segment 100Y. The shutter mechanism 9 is generally in the blocking mode and is intermittently (periodically) switched to the transmitting mode. While the shutter mechanism 9 is in the transmitting mode, a branch extending from each line segment 100Y is drawn. The branch extending from each line segment 100Y reaches the next line segment 100Y, thus forming a line 100X parallel to the X-axis. Hereinafter, a branch constituting each line 100X will also be referred to as a branch 100X. As described above, the object 50 is moved in one direction, thus a grid pattern is drawn.

A case of drawing the line segments 100Y of the pattern shown in FIG. 10A using only the first laser oscillator 2 will now be described. Controlling the imaging magnification of the second-stage zoom lens system 23 can change each pitch Px between the adjacent line segments 100Y. The width of each line segment 100Y depends on the imaging magnification of the first-stage zoom lens system 20 and that of the second-stage zoom lens system 23.

Upon changing the pitch Px by changing the imaging magnification of the second-stage zoom lens system 23, the imaging magnification of the first-stage zoom lens system 20 is changed inversely with that of the second-stage zoom lens system 23, so that the width of each line segment 100Y does not vary.

A case of drawing the grid pattern 100 shown in FIG. 10B using the first and second laser oscillators 2 and 7 will now be described. In the use of this apparatus according to the present embodiment, portions corresponding to the line segments 10Y and the branches 100X are simultaneously irradiated with laser beams. Accordingly, the following problem can be prevented: If irradiation with a laser beam emitted from the second laser oscillator 7 is delayed from that with a laser beam emitted from the first laser oscillator 2, each joint is doubly irradiated with the laser beams, so that the joint is damaged. The combining mirror 10 shown in FIG. 2 combines a laser beam for drawing the line segment 100Y with that for drawing the branch 100X such that the cross section of the laser beams are in contact with each other. Consequently, the separation of the branch 100X from the line segment 100Y can be prevented.

The shutter mechanism 29, shown in FIG. 1, blocks laser beams corresponding to redundant aerial images, thus preventing drawing of unnecessary part of a pattern. The shutter mechanism 29 may be arranged in any position so long as the paths of the laser beams split by the DOE 22 are separated from each other.

In the first embodiment, the CW laser oscillators are used as the first and second laser oscillators 2 and 7 in FIG. 2. Pulsed laser oscillators may be used.

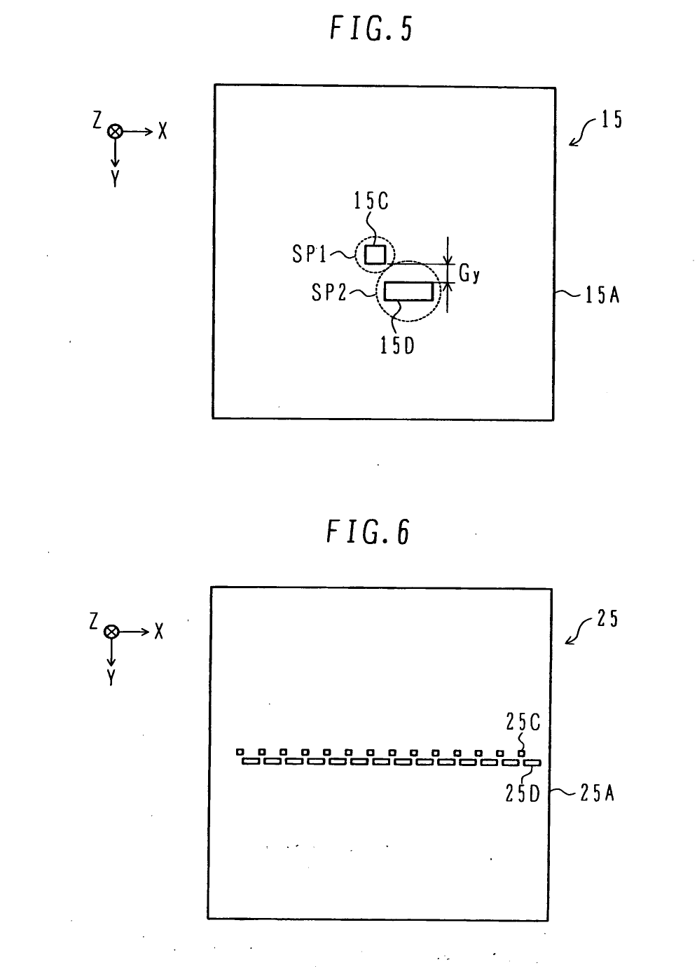

A modification of the first embodiment will now be described with reference to FIGS. 5 and 6.

FIGS. 5 and 6 are plan views of first and second masks 15 and 25 used in the laser beam irradiation apparatus according to the modification. According to the first embodiment, the first mask 15 has one through-hole 15B. According to the modification, the first mask 15 has a square through-hole 15C and a rectangular through-hole 15D extending in the X-axis as shown in FIG. 5. Those through-holes are spaced at a distance Gy in the Y-axis and are adjacent to each other in the X-axis. In other words, when the through-hole 15C is shifted in the Y-axis direction by a distance longer than the distance Gy, the through-hole 15C is come into contact with the through-hole 15D.

The through-hole 15C is arranged within the beam spot SP1 of a laser beam emitted from the first laser oscillator 2 shown in FIG. 2. The through-hole 15D is disposed within the beam spot SP2 of a laser beam emitted from the second laser oscillator 7 shown in FIG. 2. The two beam spots SP1 and SP2 may be in contact with each other similar to the first embodiment or may be away from each other.

The DOE 22, shown in FIG. 1, splits the laser beams passing through the respective through-holes 15C and 15D, thus forming a plurality of image (aerial image) patterns on the virtual plane 24. Each image pattern is similar to a pattern comprising the through-holes 15C and 15D. The image patterns are aligned in the X-axis. The rectangular aerial images, each corresponding to the through-hole 15D, and the square aerial images, each corresponding to the through-hole 15C, are arranged such that they are adjacent to each other in the X-axis.

As shown in FIG. 6, in the second mask 25, through-holes 25C and 25D are formed in positions corresponding to the aerials images similar to the through-holes 15C and 15D. The second mask 25 has a function for correcting the deviation of each of the aerial images formed by the DOE 22 from the target position and shaping each image into a target form in a manner similar to the first embodiment.

While being moved in the Y-axis direction, an object 50 shown in FIG. 1 is irradiated with the laser beams in a manner similar to the first embodiment, so that the pattern shown in FIG. 10B can be drawn. In the modification, irradiation with the laser beams for the branches 100X is time-delayed from that with the laser beams for the joints included in the line segments 100Y However, the time delay is very small. The distance by which the XY stage moves during the delay time is very short. Accordingly, the deviation between the following positions in the X-axis hardly occurs: a position where a laser beam for each branch 100X impinges and an associated position where a laser beam for the corresponding joint included in each line segment 100Y impinges. Consequently, the separation of each branch 100X from the corresponding line segment 100Y can be prevented. Further, each joint between the branch 100X and the line segment 100Y can be prevented from being overlappingly irradiated with laser beams.

In the first embodiment, laser beams passing through the partial region of the through-hole 25B of the second mask 25 in FIG. 4 form beam spots for drawing of the line segments 100Y. In other words, the edges of the beam spot corresponding to both side edges of each line segment 100Y are not lines to which both side edges of the through-hole 25B are transferred. On the other hand, in the modification, each line segment 100Y is drawn by the image of the corresponding through-hole 25C in the second mask 25. In other words, both the side edges of each through-hole 25C are transferred to form the edges of the beam spot corresponding to both the side edges of the line segment 10Y. Advantageously, the side edges of the respective line segments 100Y can be drawn clearly.

A second embodiment of the present invention will now be described with reference to FIGS. 7 to 9. According to the second embodiment, pulsed laser oscillators are used for drawing of line segments 100Y Before describing the second embodiment, an example will be explained. The beam spot of a pulsed laser beam is shaped into a square. When a given-shot beam spot is in contact with the preceding-shot beam spot without overlapping each other, a line segment 100Y is drawn. However, if a beam spot overlaps the preceding-shot beam spot, the beam spot damages a previously joined part. On the other hand, if the adjacent two beam spots are separated from each other, the line segment 100Y is broken. According to the second embodiment, the above-described problem hardly occurs.

FIG. 7 shows an example of an irradiation pattern (beam cross-section) on an object, for drawing a line segment 100Y. The beam cross-section pattern on the surface of the object includes a plurality of separated points. In this instance, it is assumed that a square grid of four rows and four columns is defined. When a section located at the Nth row and the Mth column is expressed as (N, M), beam spots are formed at eight sections (1, 1), (1, 4), (2, 2), (2, 3), (3, 2), (3, 3), (4, 1), and (4, 4) of the 16 sections in total and the laser beam does not impinge on the other eight sections.

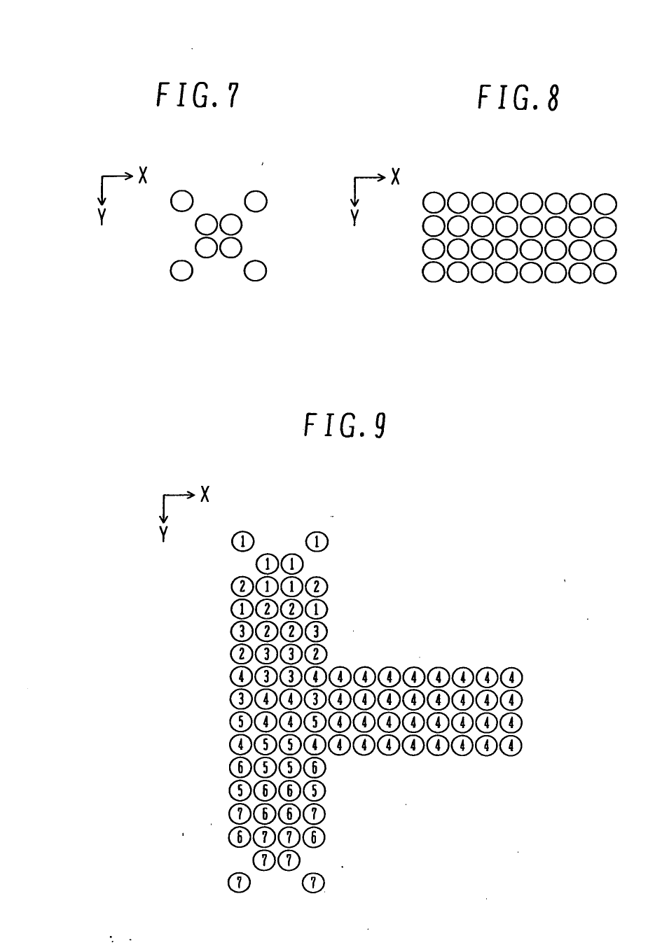

FIG. 8 shows an example of an irradiation pattern for drawing a branch 100X. Beam spots are formed at all of 32 sections of a square grid of four rows and eight columns. The grid spacing of the square grid as a reference of the irradiation pattern shown in FIG. 8 is equal to that of the square grid as a reference of the irradiation pattern shown in FIG. 7.

A pulsed laser beam for drawing the line segment 100Y is emitted from the laser oscillator 2, as shown in FIG. 2, and a pulsed laser beam for drawing the branch 100X is emitted from the other laser oscillator 7, as shown in FIG. 2. A first mask 15 shown in FIG. 1 shapes the cross-sections of the respective laser beams into the irradiation patterns shown in FIGS. 7 and 8. More specifically, in the first mask 15, through-holes for the irradiation pattern of FIG. 7 are formed in an area where the beam spot SP1 in FIG. 3 is formed and through-holes for the irradiation pattern of FIG. 8 are formed in an area where the beam spot SP2 is formed, thus shaping the beam cross-sections.

FIG. 9 shows a pattern assembly actually drawn. Each circle denotes a position irradiated with a laser beam. A number N in each circle indicates the Nth shot.

Let Pg be the grid spacing of each square grid, serving as the reference of each irradiation pattern. Each line segment 100Y to be drawn extends in the Y-axis direction. After a first-shot pulsed laser beam for drawing of the line segment 100Y is applied, a position on which the laser beam is incident is shifted in the Y-axis direction by a distance of 2×Pg and a second-shot pulsed laser beam is then applied. As for third and subsequent shots, a pulsed laser beam is similarly applied each time an incident position is shifted by 2×Pg.

For instance, upon fourth-shot laser beam application, a pulsed laser beam for drawing the branch 100X is applied.

In each line segment 100Y, any point constituting an irradiation pattern formed in a given shot does not overlap points of irradiation patterns formed in the previous and following shots. Thus, a line segment 100Y defined by a square grid of N rows and four columns is drawn. In this case, N is a natural number and depends on the length of the line segment 100Y. All of sections of the square grid of N rows and four columns are completely irradiated with pulsed laser beams.

A pulsed laser beam for drawing the branch 100X is applied every predetermined number of shots, thus forming a plurality of branches 100X arranged at regular intervals in the Y-axis direction.

In the method according to the second embodiment, each irradiation pattern for drawing the line segment 100Y includes a plurality of separate points, thus preventing overlap of irradiation patterns formed in different shots. Although each irradiation pattern includes a plurality of separate points, regions actually joined as a transferred film to a substrate become unbroken one region because of the transmission of heat. The amount of heat input in each part joined by the heat transmission is smaller than that in each part joined by direct laser-beam irradiation.

In addition, each region joined by the heat transmission is not directly irradiated with a laser beam in the next shot, in which heat is transmitted to the region. Accordingly, probably, each joined region is not damaged by the following laser-beam irradiation.

FIG. 7 shows one example of the irradiation pattern for drawing of the line segment 100Y. Other irradiation patterns are available. An available irradiation pattern will now be described below.

Each point constituting an irradiation pattern is arranged in any section of a grid of NY (NY is a natural number that is not a prime number) rows arranged in the Y-axis direction and NX (NX is a natural number) columns arranged in the X-axis direction. Regarding sections in a given column parallel to the Y-axis, points constituting the irradiation pattern are arranged at MY (MY is a factor of NY other than 1 and NY) sections of the NY sections. The distance in which the incident position of a pulsed laser beam is shifted between a shot and the next shot is MY times as long as the grid spacing in the Y-axis direction. In other words, the distance between an irradiation position in a shot and that in the next one is smaller than the dimension in the Y-axis direction of each irradiation pattern.

It is necessary to position each point constituting the irradiation pattern so that the point does not overlap points of the irradiation patterns formed in the previous and following shots.

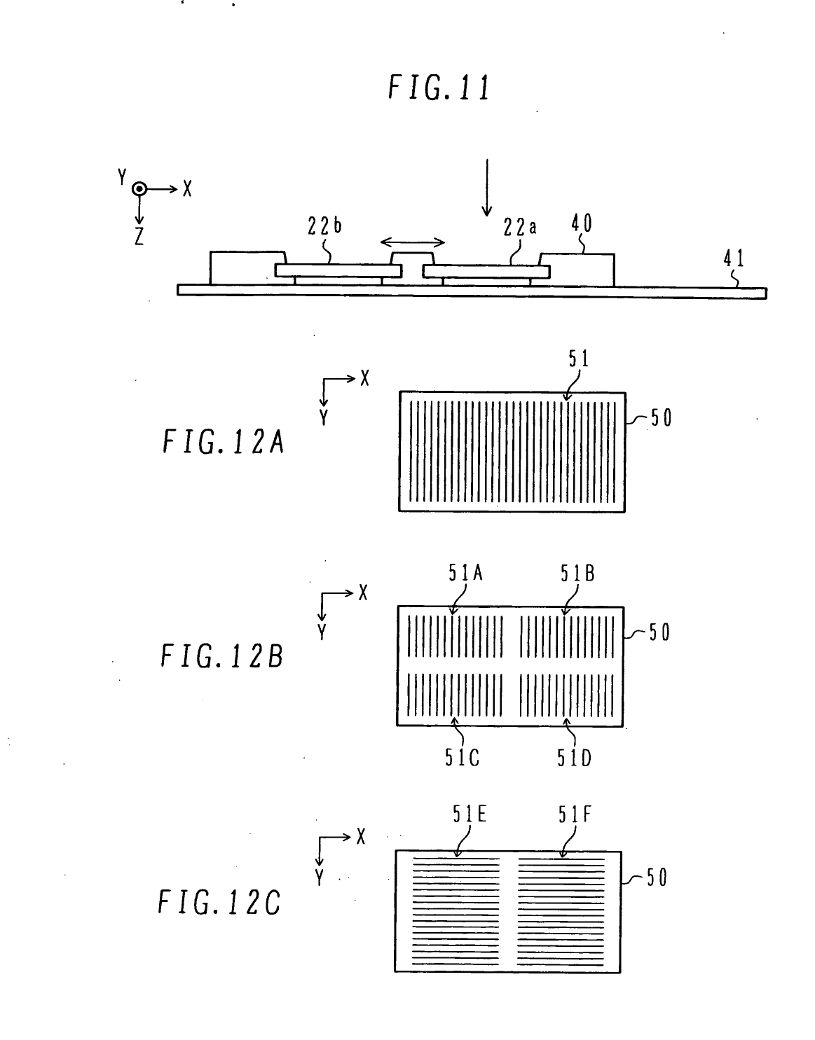

A third embodiment will now be described with reference to FIGS. 11 to 12C. In the foregoing first and second embodiments, linear patterns with branches are drawn. According to the third embodiment, simple linear patterns without branches are drawn.

FIG. 11 is a schematic diagram of a DOE support of a laser beam irradiation apparatus according to the third embodiment. According to the first embodiment, the DOE 22 splits a laser beam. According to the third embodiment, two DOEs 22a and 22b are arranged in place of the DOE 22. A DOE support 40 holds the DOEs 22a and 22b. A sliding mechanism 41 holds the DOE support 40 movably in the X-axis direction. A laser source 1 includes one laser oscillator. A first mask 15 has, e.g., a square through-hole.

The other structure of the apparatus according to the third embodiment is the same as that according to the first embodiment.

The sliding mechanism 41 moves the DOE support 40, so that any one of the DOEs 22a and 22b is selectively located on the path of a laser beam. When the DOE 22a is arranged on the laser beam path, a plurality of aerial images aligned in the X-axis direction are formed on a virtual plane 24. When the other DOE 22b is located on the laser beam path, aerial images aligned in the Y-axis direction are formed on the virtual plane 24. The direction of alignment of the aerial images formed by the DOE 22a is not necessarily orthogonal to that formed by the DOE 22b. Those directions may intersect with each other.

When an object 50 is moved in the Y-axis direction while the DOE 22a is located on the laser beam path, straight patterns extending in the Y-axis direction is drawn within an effective area 51 of the object 50 as shown in FIG. 12A. In a case where four effective areas 51A to 51D are defined on the object 50 as shown in FIG. 12B, straight patterns extending in the Y-axis direction can be drawn in each of the effective areas 51A to 51D.

When the object 50 is moved in the X-axis direction while the DOE 22b is located on the laser beam path, straight patterns extending in the X-axis direction is drawn in each of effective areas 51E and 51F of the object 50 as shown in FIG. 12C.

As described above, in each case where a plurality of line patterns extend in the X-axis direction and Y-axis direction, respectively, the use of the two DOEs 22a and 22b can achieve simultaneous drawing of the line patterns.

When the object 50 is rotated by 90°, the similar patterns can be drawn. However, this approach has the following problem: Generally, as the screen size of a thin-shaped display increases, the size of a substrate therefore increases. In drawing patterns on the substrate, a stage mechanism for rotating the substrate has a tendency to move unevenly, leading to degradation of pattern positioning accuracy. According to the third embodiment, it is unnecessary to rotate the substrate. Advantageously, a stage mechanism need not rotate.

According to another approach, rotating the DOE 22 shown in FIG. 1 by 90° can achieve drawing of the similar patterns. In rotating a DOE, however, it is difficult to align the rotation center of the DOE to the optical axis of another optical element. Disadvantageously, misalignment of drawn patterns may easily occur due to an error in positioning the DOE. According to the third embodiment, since the DOE is not rotated, misalignment of patterns hardly occurs.

While the present invention has been described by reference to specific embodiments, it will be apparent to those skilled in the art that the invention is not limited to the foregoing embodiments but various changes, modifications, and combinations are possible within the spirit and scope of the invention defined in the following claims.

What is claimed is:

1. A laser beam irradiation apparatus comprising:
a laser source emitting a laser beam;
a diffractive optical element arranged such that the laser beam emitted from the laser source is incident on the diffractive optical element, the diffractive optical element splitting the incident laser beam into a plurality of laser beams; and
a first zoom lens system on which the split laser beams are incident, the system focusing the respective incident laser beams onto a first virtual plane.

2. The laser beam irradiation apparatus according to claim 1, further comprising:
a first mask arranged on the path of the laser beam between the laser source and the diffractive optical element, the mask shaping the cross section of the passing laser beam; and
a second zoom lens system focusing the beam cross-section shaped by the first mask onto a second virtual plane to form an aerial image, wherein
the diffractive optical element and the first zoom lens system provide an image of the aerial image formed on the second virtual plane onto the first virtual plane by each of the plurality of the laser beams split by the diffractive optical element.

3. The laser beam irradiation apparatus according to claim 1, wherein
the laser source includes:
first and second laser oscillators each emitting a laser beam; and
an optical-path combiner changing the paths of the respective laser beams emitted from the first and second laser oscillators such that the traveling direction of the laser beam emitted from the first laser oscillator is parallel to that of the laser beam emitted from the second laser oscillator and the cross sections of the respective laser beams are in contact with each other, and emitting the resultant laser beams.

4. The laser beam irradiation apparatus according to claim 3, wherein the laser source further includes a first shutter mechanism arranged on the path of the laser beam between the first laser oscillator and the optical-path combiner, the first shutter mechanism preventing the laser beam from entering the optical-path combiner for a period.

5. The laser beam irradiation apparatus according to claim 1, further comprising:
a stage holding an object to be irradiated;
mask holder for exchangeably holding a plurality of second masks along the first virtual plane; and
a transfer optical system for transferring the aerial images formed on the first virtual plane onto the surface of the object held by the stage, wherein
each of the second masks has a laser-beam transmission area corresponding to a position at which the laser beams split by the diffractive optical element pass across the first virtual plane; and
the laser-beam transmission area defined in each second mask is smaller than the cross section of the laser beam on the second mask.

6. The laser beam irradiation apparatus according to claim 5, wherein
the diffractive optical element splits the laser beam so that the aerial images are aligned in a first direction on the first virtual plane, and
the stage is capable of moving the object in the direction perpendicular to the direction of alignment of the images transferred on the object.

7. The laser beam irradiation apparatus according to claim 6, wherein the optical-path combiner combines the paths of the laser beams emitted from the first and second laser oscillators such that the cross section of the laser beam emitted from the first laser oscillator is aligned to that of the laser beam emitted from the second laser oscillator in the first direction.

8. The laser beam irradiation apparatus according to claim 5, further comprising:
a second shutter mechanism arranged in a position, where the laser beams pass, between the first zoom lens system and the stage, the second shutter mechanism being capable of blocking one or some of the split laser beams so as not to reach the object on the stage.

9. The laser beam irradiation apparatus according to claim 1, wherein
the diffractive optical element includes first and second elements, the first element splitting the laser beam so as to align an aerial images in the first direction on the first virtual plane, the second element splitting the laser beam so as to align an aerial images in a second direction intersecting the first direction on the first virtual plane, and
the laser beam irradiation apparatus further includes a support for movably supporting the diffraction optical element such that either the first or second element is selectively arranged in a position which the laser beam passing across the first virtual plane is incident on.

10. The laser beam irradiation apparatus according to claim 2, wherein
at least first and second transmission areas are defined in the first mask such that when an XY orthogonal coordinate system is defined on the surface of the first mask, the first and second transmission areas are separated from each other in the Y-axis direction and are adjacent to each other in the X-axis direction without overlapping,
the laser source includes a first laser oscillator emitting a first laser beam and a second laser oscillator emitting a second laser beam, the beam spot of the first laser beam including the first transmission area on the first mask, the beam spot of the second laser beam including the second transmission area on the first mask, the traveling directions of the first and second laser beams being parallel to each other on the first mask, and
the laser source includes a first shutter mechanism arranged on the path of the first laser beam between the first laser oscillator and the first mask, the first shutter mechanism preventing the first laser beam from entering the first mask for a period.

11. A method for drawing a pattern, comprising the steps of:
adjusting the axes of first and second laser beams such that the beam spots of the first and second laser beams are aligned in contact with each other in a first direction on the surface of an object to be processed; and
moving the object such that the incident positions of the first and second laser beams move from a start point to an end point in a second direction intersecting the first direction while continuously applying the first laser beam from the start point to the end point and intermittently applying the second laser beam, thus drawing a pattern including a line and branches extending from the line.

12. A method for drawing a pattern, comprising the steps of:
shaping the cross section of a pulsed laser beam so that the cross section includes a plurality of separated points, constituting an irradiation pattern, on the surface of an irradiated object; and
moving the incident position of the pulsed laser beam in a first direction while applying the laser beam onto the object, wherein
a travel distance between the incident position in a shot and that in the next shot is shorter than the dimension in the first direction of the irradiation pattern of the pulsed laser beam; and
the irradiation pattern and the travel distance are selected so that any of the points constituting the irradiation pattern formed in a shot does not overlap points of irradiation patterns formed in the previous and following shots.

13. The method according to claim 12, wherein
each point constituting the irradiation pattern of the pulsed laser beam is located at any of sections of a grid in which NY (NY is a natural number that is not a prime number) sections are arranged in the first direction and NX (NX is a natural number) sections are arranged in a second direction orthogonal to the first direction,
in sections included in a given column parallel to the first direction, points constituting the irradiation pattern are located at MY (MY is a factor of NY other than 1 and NY) sections of the NY sections and the travel distance is MY times as long as the grid spacing in the first direction.
